(19) United States
(12) Patent Application Publication
(10) Pub. No.: US 2007/0106727 A1
(43) Pub. Date: May 10, 2007

(54) Method and device for establishing a collaboration session

(76) Inventor: Laurent Mainard, Verin Le Coquet (FR)

Correspondence Address: Gerald E Helget;Briggs and Morgan, 80 South Eighth Street, Suite 2200, Minneapolis, MN, 55402, US

(21) Appl. No.: 10/580,299

(22) PCT Filed: Dec. 8, 2004
(86) PCT No.: PCT/FR04/03164

§ 371 Date: Jul. 28, 2006

(30) Foreign Application Priority Data
Dec. 9, 2003 (FR) 0314430

(51) Int. Cl. G06F 15/16

(52) U.S. Cl. 709/205

(57) ABSTRACT

The invention concerns a method of transferring at least one message for the establishment of a collaboration session (126) by a collaboration session manager (125) between a plurality of clients, characterised in that a messaging system (122) is associated with the collaboration session manager (125) and in that the method comprises the steps of the reception, by the messaging system associated with the collaboration session manager, of a message generated by a client of a collaboration session, the message comprising a plurality of addresses of clients of the collaboration session, of activation of a collaboration session by the collaboration session manager (125), of obtaining an address of the activated collaboration session and of transfer of at least one message intended for each collaboration session client address for establishing the collaboration session, the message comprising the address of the collaboration session activated. The invention also concerns an associated device and system.

The present invention concerns a method and device for establishing a collaboration session over a communication network between a plurality of clients.

More precisely, the invention is situated in the field of the simplification of collaboration session establishment commands.

The use of collaboration services such as workspace sharing sessions or video conference sessions requires, for a client of such services, the execution of a large number of operations before being able to use these services.

Conventionally, a client initiating a collaboration session must, before being able to use the services being offered by the session, open a collaboration session, define a name or address of the collaboration session opened, define the other clients of the collaboration session, or even associated passwords for the use of this collaboration session, and inform the other clients of the opening of the collaboration session. The initiating client must also communicate the name or address of this collaboration session as well as the passwords associated with this session, and finally activate the client collaboration software corresponding to the collaboration session opened.

The large number of operations that the user must perform when a collaboration session is established thus makes these services difficult to use and establish.

Very often, the same information must be communicated several times by the client initiating a collaboration session. For example, the client initiating the opening of a collaboration session must define the name or address of the collaboration session opened and then communicate, to each other client with which he envisages sharing the collaboration session, the name or address of the collaboration session opened.

These many transfers of this information make the establishment of a communication session tedious for an initiating client and thus makes wide use of such services disadvantageous.

Thus there does not exist in the prior art any collaboration session establishment system that is simple and rapid for the clients of these services to use.

The aim of the invention is to resolve the drawbacks of the prior art by proposing a collaboration session establishment method in which the tasks of a client of such services are reduced and simplified.

To this end, according to a first aspect, the invention proposes a method of transferring at least one message for the establishment of a collaboration session by a manager of a collaboration session between a plurality of clients, characterised in that a messaging system is associated with the collaboration session manager and in that the method comprises the steps of:
the reception, by the messaging system associated with the collaboration session manager, of a message generated by a collaboration session client, the message comprising a plurality of addresses of clients of the collaboration session,
the activation of a collaboration session by the collaboration session manager,
the obtaining of an identifier for the collaboration session activated,
the transfer, for the establishment of the collaboration session, of at least one message intended for each collaboration session client address, the message comprising the identifier of the collaboration session activated.

Correspondingly, the invention proposes a device for transferring at least one message for the establishment of a collaboration session by a collaboration session manager between a plurality of clients, characterised in that messaging is associated with the collaboration session manager and the device comprises:
means for the reception, by the messaging system associated with the collaboration session manager, of a message generated by a collaboration session client, the message comprising a plurality of addresses of clients of the collaboration session,
means for the activation of a collaboration session by the collaboration session manager,
means for the obtaining of an identifier for the collaboration session activated,
means for the transfer, for the establishment of the collaboration session, of at least one message intended for each collaboration session client address, the message comprising the identifier of the collaboration session activated.

Thus the tasks that a client must perform when a collaboration session is established are simplified.

It is no longer necessary for a client initiating a collaboration session to define an identifier for a collaboration session and to communicate this identifier to the other clients of the collaboration session.

According to another aspect of the invention, the message generated by the client initiating the collaboration session is an electronic message comprising the messaging address of the client initiating the session and the messaging address of at least one other client of the collaboration session.

Thus, by transferring messages in the form of electronic messages, the information included in the message can be directly interpreted by a device such as a computer.

It should be noted here that electronic mail and instantaneous messaging are in particular included in the term electronic message.

In addition, by generating an electronic message intended for the collaboration session manager and clients with which the initiator wishes a collaboration session to be established, the initiating client, by a single electronic message transfer, transfers to the collaboration session manager the information necessary for establishing a collaboration session whilst informing the other clients of an imminent establishment thereof.

According to another aspect of the invention, temporal information is associated with the electronic message.

The temporal information associated with the electronic message makes it possible to define a time of establishing the collaboration session and the duration of the collaboration session.

According to another aspect of the invention, other messaging addresses are included in the electronic message and there are determined, amongst the messaging addresses included in the electronic message, the messaging addresses of the clients of the collaboration session.

Thus the same electronic message can be used for different purposes. The electronic message indicates the clients with which the initiating client wishes to share a collaboration session. The electronic message also makes it possible to inform third parties of the establishment of the collaboration session.

According to another aspect of the invention, a plurality of messaging addresses are associated with the messaging system associated with the collaboration session manager, and a type of collaboration session corresponds to each messaging address.

Thus the collaboration session manager can manage a plurality of collaboration sessions of different types and in a simple manner determine which type of collaboration session must be activated.

The collaboration session manager being able to manage a plurality of collaboration sessions of different types, it is not necessary to implement one collaboration session manager per type of collaboration session.

According to another aspect of the invention, accreditations are allocated to the clients of the collaboration session and the message transferred to each client of the collaboration session comprises the allocated accreditation.

Thus access to a collaboration session is made secure.

The client initiating an establishment of a collaboration session no longer needs to communicate this type of information to the other clients. This is performed automatically according to the present invention.

The invention also concerns a method of establishing a collaboration session between a plurality of clients of the collaboration session over a communication network, characterised in that the method comprises the steps of the reception, by a messaging system associated with a client of the collaboration session, of at least one message generated by a messaging system associated with a collaboration session manager, the message comprising the identifier of a collaboration session activated, and the establishment, by the collaboration software associated with the client, of a collaboration session from the identifier of the collaboration session activated.

Correspondingly, the invention proposes a device for establishing a collaboration session between a plurality of clients of the collaboration session over a communication network, characterised in that the device comprises means for the reception, by a messaging system associated with a client of the collaboration session, of at least one message generated by a messaging system associated with a collaboration session manager, the message comprising the identifier of a collaboration session activated, and means for the establishment, by the collaboration software associated with the client, of a collaboration session from the identifier of the collaboration session activated.

Thus the establishment of a collaboration session is effected automatically without the clients of the communication session having to perform any operation.

The establishment of a collaboration session is thus simplified.

According to another aspect of the invention, the message generated by the messaging associated with a collaboration session manager is an electronic message and temporal information is associated with the electronic message.

Thus, by transferring messages in the form of an electronic message, the information included in the message can be interpreted directly by a device such as a computer.

In addition, the temporal information associated with the electronic message makes it possible to define a time of establishing a collaboration session and the duration of the collaboration session.

According to another aspect of the invention, prior to the establishment of the session, the identifier of the collaboration session is displayed and a command effected by the client for establishing the collaboration session is detected.

Thus, by a simple command, a client accesses a collaboration session. The operations necessary for establishing a collaboration session are thus reduced.

According to another aspect of the invention, prior to the establishment of a collaboration session, the collaboration software associated with the client is activated.

Thus the tasks of the client are simplified.

According to another aspect of the invention, a message intended for the messaging associated with the collaboration session manager is generated by means of the messaging associated with the client initiating the collaboration application, the message including the addresses of the messaging systems of the clients of the collaboration session.

The invention also concerns a system for establishing a collaboration session between a plurality of clients of the collaboration session over a communication network, characterised in that the system comprises:
means of generating, by means of a messaging system associated with a client initiating the collaboration application, a message intended for a messaging system associated with a collaboration session manager, the message including the address of the clients of the collaboration session,
means for the activation of a collaboration session by the collaboration session manager,
means of obtaining an identifier of the collaboration session activated,
means for the transfer, for establishing the collaboration session, of at least one message intended for each collaboration session client address, the message comprising the identifier of the collaboration session activated,
means for the establishment, by the collaboration software associated with the client, of a collaboration session from the identifier of the collaboration session activated.

The invention also concerns the computer program stored on an information medium, the said programs containing instructions for implementing the methods described above, when they are loaded into and executed by a computer system.

The characteristics of the invention mentioned above, as well as others, will emerge more clearly from a reading of the following description of an example embodiment, the said description being given in relation to the accompanying drawings, amongst which:

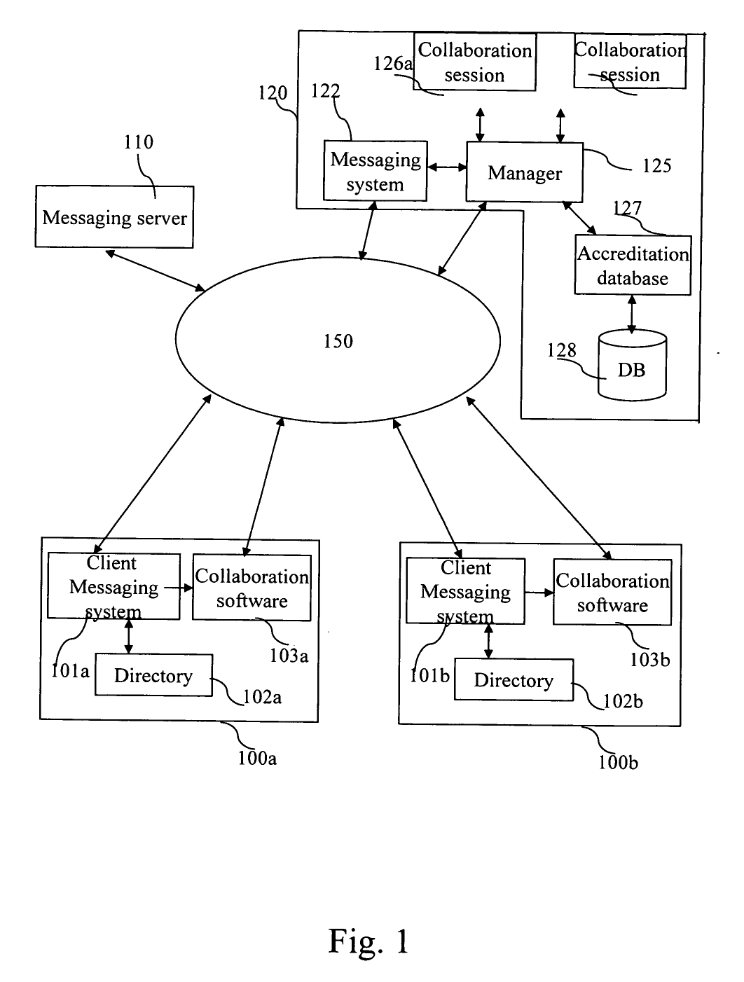

FIG. 1 depicts the system for establishing a collaboration session between a plurality of clients in a communication network;

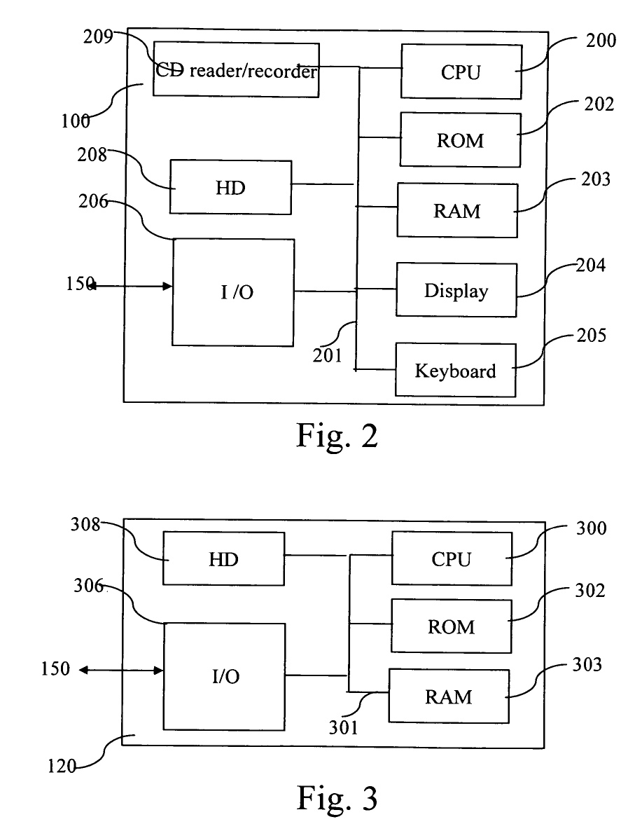

FIG. 2 depicts the block diagram of a client communication device according to the invention;

FIG. 3 depicts the block diagram of a collaboration session activation device for establishing a collaboration session between a plurality of clients according to the invention;

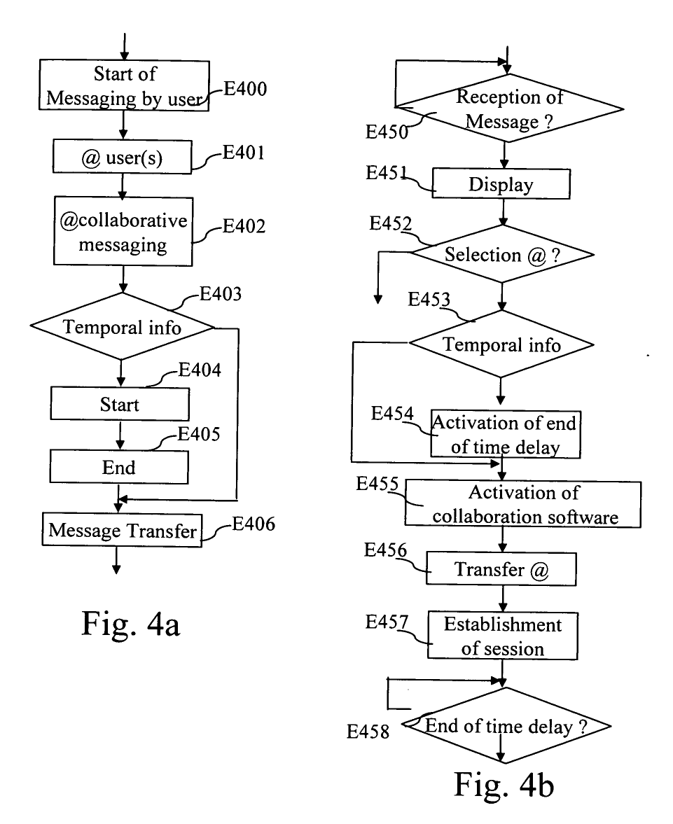

FIG. 4a depicts the algorithm implemented by a client communication device for initiating an establishment of a collaboration session between a plurality of clients according to the invention;

FIG. 4b depicts the algorithm implemented by a client communication device for establishing a collaboration session between a plurality of clients according to the invention;

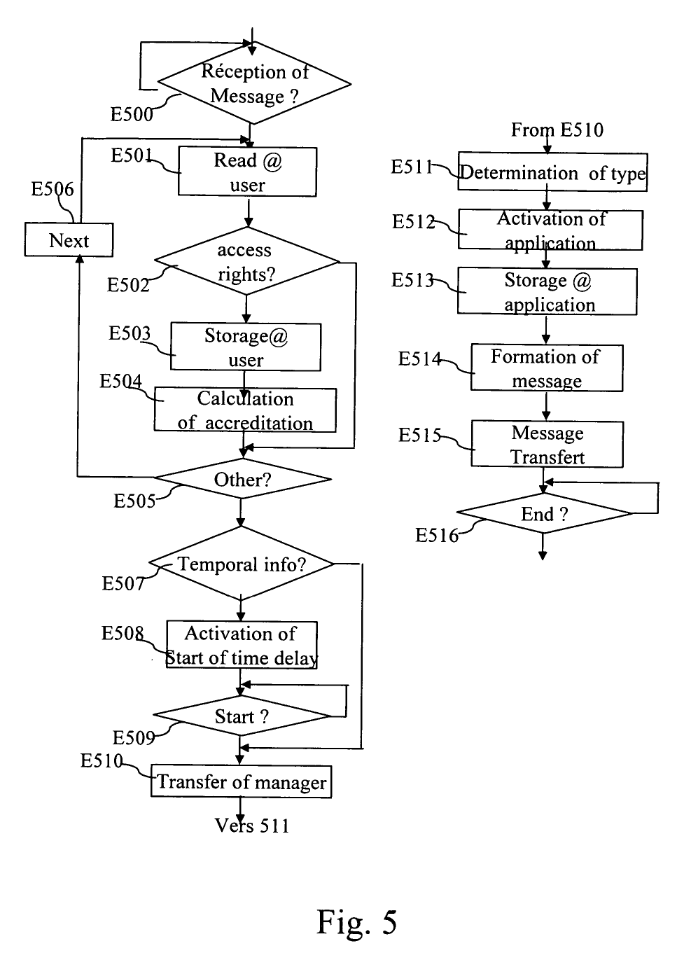

FIG. 5 depicts the algorithm implemented by the collaboration session activation device for establishing a collaboration session between a plurality of clients according to the invention.

FIG. 1 depicts the system for establishing a collaboration session between a plurality of clients in a communication network.

The system according to the invention comprises a collaboration session activation device 120 that activates the collaboration sessions between a plurality of clients 100 over a communication network 150.

Only two client communication devices 100a and 100b are depicted at FIG. 1.

Naturally a larger number of client communication devices are present in such a system. They are not shown here for reasons of clarity.

In the system for establishing a collaboration session between a plurality of clients in a communication network, a client communication device, for example the client communication device 100a, generates an electronic message intended for each client communication device 100, for example the client communication device 100b, with which it wishes to establish a collaboration session.

The electronic message comprises any type of digital data sent and in particular an electronic mail or message of the SMS type or and MMS message or an instantaneous message known by the English term “Instant Messaging”.

Messages of the SMS type are short messages. SMS is the abbreviation for the English words Short Message Service.

Messages of the MMS (Multimedia Message Service) type are short messages that include sequences of video images or music.

The client communication device 100a sends this same electronic message to a message handling system 122 associated with a collaboration session manager 125 of the collaboration session activation device 120.

The collaboration session activation device 120, on receiving this electronic message, activates a collaboration session and generates an electronic message for client communication devices 100a and 100b.

The electronic message is for example, and non-limitingly, an electronic mail or in a variant a message of the SMS type or an MMS message or an instantaneous message.

This electronic message comprises amongst other things an identifier for the collaboration session activated. This identifier is for example the address of the collaboration session activated. The identifier can also be a name associated with the collaboration session activated.

Following the reception of this electronic message, the collaboration software 103a and 103b of the respective client communication devices 100a and 100b is activated and the collaboration session is established between the two client communication devices 100. The collaboration session is a multiclient application such as for example an audio visual conference, a telemeeting, or the sharing of a common document or software editing space.

Each client communication device 100 comprises at least one item of messaging software 101 with which there is possibly associated a directory of addresses of correspondents 102 of the client of the client communication device 100 and collaboration software 103.

Each client communication device 100 comprises in a variant instantaneous messaging software or software able to process SMS or MMS messages.

Collaboration software 103 is for example videoconference software or editing software enabling the user of a client communication device 100 to participate with other clients in a collaboration session in the form of a whiteboard.

A whiteboard is a tool that enables several clients to work on text or graphical data by taking up the concept of a board. All the clients see what appears on the board and all the clients can write on the board.

The communication network 150 allows the transfer of information between the client communication device 100, at least one messaging server 110 and the collaboration session activation device 120.

The communication network 150 is preferentially a communication network of the Internet type. It can also be a wireless telephone network or the like.

The collaboration session establishment system according to the present invention comprises at least one messaging server 110.

The messaging server 110 receives the messages transmitted by the client messaging software 101 and distributes them to their destinations.

In a variant, the messaging server 110 is a server able to process instantaneous messages or SMS or MMS messages.

The collaboration session activation device 120 comprises one or more messaging software packages 122 associated with a collaboration session manager 125.

The messaging software package or packages 122 are software packages able to process any type of digital data sent and in particular electronic mails or instantaneous messaging mails or SMSs or MMSs.

The collaboration session manager 125 activates collaboration sessions 126 and manages the various information exchanges between the clients when the collaboration session is established. By way of example, only two collaboration sessions 126a and 126b are shown. Naturally the collaboration session manager 125 is able to provide the management of a larger number of collaboration sessions 126.

When the collaboration session manager 125 establishes a collaboration session, the manager firstly activates a collaboration session and communicates to the clients of the collaboration session the identifier for it so that they can establish the collaboration session.

The activation of a collaboration session corresponds to the starting of the corresponding software of the collaboration session requested by an initiating client, and to the establishment of the resources necessary to the collaboration session between the clients at the collaboration session activation device 120.

These resources are for example memory space or the starting of applications allowing the transit of information between the clients.

Accreditation verification software 127, with which a database 128 is associated, is associated with the collaboration session manager 125.

The accreditation verification software 127 verifies that all the clients whose electronic message addresses are included in a message sent by a user of a client communication device 100 have rights for accessing the collaboration session requested.

These rights are for example obtained by registering previously with the service as offered by the collaboration session activation device 120.

According to a particular embodiment, the accreditation verification software 127 determines, for the client sending the message and for each of the destinations of the message, a temporary password or accreditation.

According to a particular embodiment of the present invention, several messaging addresses are associated with the collaboration session manager 125. According to this particular embodiment, a type of collaboration session corresponds to a messaging address.

FIG. 2 shows the block diagram of a client communication device according to the invention.

The client communication device 100 is adapted to function in a system for establishing a collaboration session between a plurality of clients in a communication network 150.

The client communication device 100 is for example a microcomputer. It can also be integrated in a personal assistant or in a mobile telephone.

The client communication device 100 comprises a communication bus 201 to which there are connected a central unit 200, a read-only memory 202, a random-access memory 203, a display 204, a keyboard 205, a hard disc 208, a reader/recorder of removable storage means 209 and an interface 206 for communication with a communication network such as the Internet communication network 150.

The hard disc 208 stores amongst other things the client messaging software 101 and the directory 102 associated with it, the collaboration software 103 and the programs implementing the invention, which will be described subsequently with reference to FIGS. 4a and 4b.

The client messaging software 101 is able to process any type of digital data sent and in particular electronic mails. In a variant, the client messaging software 101 is able to process instantaneous messages or SMSs or MMSs.

The programs implementing the invention can also be read by means of the reader of removable storage means 209 or received via the communication network 150.

In more general terms, the programs according to the present invention are stored in a storage means. The storage means can be read by a computer or microprocessor 200. This storage means is integrated or not in the device, and may be removable.

It should be noted that, when the communication device is a personal assistant known by the term PDA, or a mobile telephone, the hard disc 208 is replaced by an information storage means such as for example a memory of the SDRAM type.

When the client communication device 100 is powered up, or when the client messaging software 101 is started, the programs according to the present invention are transferred into the random access memory 203, which then contains the executable code of the invention as well as the data necessary for implementing the invention.

The client communication device 100 comprises a display 204 able to reproduce the messages received from the messaging service 110 or from the collaboration session activation device 120 according to the present invention.

The client communication device 100 also comprises a keyboard 205 also serving as a man/machine interface. By means of this keyboard 205, the initiating client can compose an electronic message, including therein the electronic message addresses of the clients with which he wishes a collaboration session to be established or their telephone number when SMS or MMS messages are transmitted. In this same electronic message, the initiating client also includes the electronic messaging address of the collaboration session activation device 120.

By means of the keyboard 205, the user of the client communication device 100 can also, by selecting the address of the collaboration session transmitted in the form of an electronic message sent by the collaboration session activation device 120, activate the collaboration software 103 and establish a collaboration session at the address of the collaboration session activated.

It should be noted here that the keyboard 205 can also be replaced by a touch screen, a mouse or any other type of man/machine interface.

FIG. 3 depicts the block diagram of a collaboration session activation device for establishing a collaboration session between a plurality of clients according to the invention.

The collaboration session activation device 120 is for example a computer.

The collaboration session activation device 120 comprises a communication bus 301 to which there are connected a central unit 300, a read-only memory 302, a random access memory 303, a hard disc 308 and an interface 306 for communication with a communication network 150 such as the Internet.

The hard disc 308 stores the program implementing the invention that will be described subsequently with reference to FIG. 5.

The hard disc 308 also stores the collaboration session management software 125 and the messaging software 120 associated with it.

The hard disc also stores the accreditation software 127 and the database 128 associated with it.

When the collaboration sessions are activated, the processor 300 of the collaboration session activation device 120 allocates a collaboration space in the random access memory 303.

In more general terms, the programs according to the present invention are stored in a storage means. This storage means can be read by a computer or a microprocessor 300. This storage means is integrated or not in the device, and may be removable.

When the collaboration session activation device 120 is powered up, the program that will be described subsequently with reference to FIG. 5 is transferred into the random access memory 303, which then contains the executable code of the invention as well as the data necessary for implementing the invention.

The input/output interface 306 is a communication interface able to provide information exchanges by means of the network 150 with the users of the client communication terminals 100.

FIG. 4a shows the algorithm implemented by a client communication device for initiating an establishment of a collaboration session between a plurality of clients according to the invention.

According to this algorithm, a user of a client communication device 100 initiates the activation and establishment of a collaboration session by the sending of an electronic message.

The electronic message is an electronic mail or in a variant a message of the SMS type or an MMS message or an instantaneous message.

The processor 200 of the client communication device 100 reads, from the memory 202, the instructions of the program corresponding to steps E400 to E406 of FIG. 4a and loads them into random access memory 203 in order to execute them.

At step E400, the client messaging software 101 is started by the user of the client communication device 100.

Once this operation has been performed, the processor 200 of the client communication device passes to the following step E401.

This step consists of the entering of at least one electronic messaging address of a client with whom the user of the client communication device 100 wishes a collaboration session to be established or of at least one telephone number.

By way of example, the user of the client communication device 100a enters the electronic messaging address of the user of the client communication device 100b. The entry is effected by means of the keyboard 205 and/or from the directory 102a associated with the client messaging system 101a.

Naturally several messaging addresses and/or telephone numbers can be inserted at this step.

In addition, the user of the client communication device 100a can also indicate electronic messaging addresses other than those associated with the clients with which he wishes a collaboration session to be established.

These other electronic messaging addresses are the electronic messaging addresses of addressees for whom the message has only a purely informative character. These other addresses are for example identified by information such as “copied”.

Once this operation has been performed, the processor 200 of the client communication device passes to the following step E402.

At this step, the user of the client communication device 100a enters the electronic messaging address of the collaboration session activation device 120.

It should be noted here that the user of the client communication device 100a chooses the electronic messaging address corresponding to the collaboration session type that he wishes to initiate.

If this session is a video conferencing session, the client inserts for example the address videoconference@domain.com.

If the session is an editing session in the form of a whiteboard, the client inserts for example the address whitboard@domain.com.

In a variant, a single electronic messaging address is associated with the collaboration session activation device and the client specifies in the body of the electronic message, by means of a predetermined key word, the type of session that he wishes to see initiated.

Once this step has been performed, the processor 200 passes to the following step E403 and determines whether or not temporal information is associated with the electronic message being formed.

This temporal information is for example the required date and/or time of establishment of the collaboration session or even the time of ending of the collaboration session.

This temporal information is associated in the form of an attachment to the electronic message. This attachment is for example of the eCalendar© or vCalendar© type.

If no temporal information is associated with the electronic-message being formed, the processor 200 next passes to step E406.

If temporal information is associated with the electronic message being formed, the processor 200 passes to the following step E404.

At step E404, the processor 200 invites the user of the client communication device 100a to enter the date and/or time of establishment of the collaboration session.

Once this operation has been performed, the processor 200 passes to the following step E405 and invites the user of the client communication device 100a to enter the date and/or time of the end of the collaboration session.

Once this operation has been performed, the dates and/or times of the start and end of the collaboration session are inserted in the electronic message according to a format predetermined by the processor 200.

The electronic message thus formed is transferred at step E406 to the messaging server 110 by means of the communication interface 206 and communication network 150.

The electronic message thus comprises the electronic messaging address of the collaboration session activation device 120 and more precisely the electronic messaging address corresponding to the type of collaboration session that it wishes to initiate, the electronic messaging address of the user of the client communication device 100a initiating the collaboration session as well as the electronic messaging address or the telephone number of the user of the client communication device 100b with whom the user of the client communication device 100a wishes to share the collaboration session.

It should be noted here that, in a variant, steps E403 to E405 are not performed. The processor 200, when step E402 is executed, transfers the electronic message to the messaging server 110.

It should be noted here that, in another embodiment, for example when the client communication device is a telephone handset, the message is transmitted in the form of a message of the SMS or MMS type.

FIG. 4b depicts the algorithm implemented by a client communication device for establishing a collaboration session between a plurality of clients according to the invention.

The processor 200 of the client communication device 100 reads, from the memory 202, the instructions of the program corresponding to steps E450 to E458 in FIG. 4b and loads them into random access memory 203 in order to execute them.

The algorithm in FIG. 4b is executed both by the client communication device 100a initiating the establishment of a collaboration session and by each client communication device 100 with which the user of the client communication device 100a wishes a collaboration session to be established.

Step E450 of the algorithm in FIG. 4b is a loop awaiting the reception by the client messaging software 101 of an electronic-message generated by the collaboration session activation device 120.

On reception of an electronic message generated by the collaboration session activation device 120, the processor 200 of the client communication device 100 passes to the following step E451.

The electronic message is for example an electronic mail or in a variant a message of the SMS type or an MMS message or an instantaneous message.

At step E451, the electronic message received is displayed on the display 204 of the client communication device 100.

This electronic message comprises for example text information such as:

“Hello, A collaboration session has been created, click on the following link to join it: Space.abc.com/sidjsGwqAXg80/CFGMA?csl=m1&ms1=m1&xsl=1&out=2.”

At the following step E452, the processor 200 determines whether or not the user of the communication device selects the link offered in the electronic message received. This selection is made by means of the keyboard 204 or a mouse associated with the client communication device 100.

If the user of the communication device does not select the link offered, the algorithm according to the present invention ends. The processor 200 returns to step E450 awaiting the reception of a new electronic message.

If the user of the communication device selects the link offered, the processor 200 passes to the following step E453.

At this step, the processor 200 determines whether temporal information is contained in the electronic message received or is associated therewith.

This temporal information is for example the date and/or time at the end of the collaboration session desired or even the time of establishment of the collaboration session.

This temporal information is associated in the form of an attachment to the electronic message. This attachment is for example of the eCalendar© or vCalendar© type. In another embodiment, this temporal information is inserted in the electronic message according to a predetermined format.

If no temporal information is contained in the electronic message or associated with it, the processor 200 passes to step E455.

If temporal information is contained in the electronic message, the processor 100 passes to step E454.

At this step, the processor 200 activates an end of collaboration session time delay. This time delay is determined from temporal information contained in the electronic message or associated with it.

Once this operation has been performed, the processor 200 then passes to step E455.

It should be noted here that, if start of collaboration session information is included in the electronic message and this does not correspond to the time and date of the clock and/or calendar of the client communication device 100, the processor 200 waits until these are identical before passing to step E455.

At step E455, the processor 200 activates the collaboration software 103.

Once this operation has been performed, the processor 200 passes to the following step E456.

At this step, the link included in the electronic message received and selected at step E452 is transferred to the collaboration software 103.

The collaboration software 103 establishes at step E457 a collaboration session at the address of the collaboration session.

When this session is established, the accreditations that were communicated by the collaboration session activation device 120 are if necessary communicated.

Each client communication device 100 receiving the same type of message executes the present algorithm and each client communication device user 100 is thus, by making a simple command, in communication with the other clients by means of the collaboration session established.

This collaboration session remains active as long as the test of the following step E458 is not positive. At this test, the processor 200 checks whether or not the end of collaboration session time delay established at step E454 has terminated.

When the end of session time delay has terminated, the processor 200 demands the closure of the collaboration software 103 and returns to step E450, awaiting the reception of a new message.

FIG. 5 shows the algorithm implemented by the collaboration session activation device for establishing a collaboration session between a plurality of clients according to the invention.

The processor 300 of the collaboration session activation device 120 reads, from the read-only memory 302 or hard disc 308, the instructions of the program corresponding to steps E500 to E516 of FIG. 5 and loads them into random access memory 303 in order to execute them.

According to this algorithm, the processor 300 of the collaboration session activation device 120 detects the reception of a message generated by a client initiating a collaboration session, demands the activation of the collaboration session, obtains the address of the collaboration session activated and transfers at least one message comprising the address of the collaboration session activated to each address or telephone number of clients of the collaboration session.

Step E500 of the algorithm of FIG. 5 is a loop awaiting the reception by the messaging software 122 of an electronic message generated by a user initiating a client communication device 100.

This message corresponds to the electronic message formed according to the algorithm in FIG. 4a and transferred at step E406 of this same algorithm.

This message may also, in another embodiment, be a message of the SMS or MMS type as described with reference to FIG. 4a.

On reception, by the messaging software 122, of an electronic message generated by a user of a client communication device 100, the processor 300 of the collaboration session activation device passes to the following step E501.

At step E501, the collaboration session manager 125 reads in the electronic message received an electronic messaging address of a client of the collaboration service.

Once this operation has been performed, the collaboration session manager 125 checks at the following step E502 whether the client having the messaging address read at step E501 is accredited to use the service as proposed by the present invention.

For this purpose, the collaboration session manager 125 interrogates accreditation verification software 127 with which a database 128 is associated.

The accreditation verification software 127 checks whether the client whose messaging address was read at step E501 has rights for accessing the collaboration application requested.

These rights are for example obtained by the clients by previously registering with the service as proposed by the collaboration session activation device 120.

If the client having the messaging address or the telephone number read at step E501 is not accredited to use the service as proposed by the present invention, the processor 300 of the collaboration session activation device 120 passes to step E505.

If the client having the telephone number or messaging address read at step E501 is accredited to use the service as proposed by the present invention, the processor 300 passes to step E503.

At this step, the address read at step E501 is stored.

Once this operation has been performed, the collaboration session manager 125 interrogates the accreditation verification software 127 so that the latter determines at step E504 a temporary password or accreditation, for accessing the service.

This accreditation is stored at this same step in association with the electronic messaging address stored at the previous address E503.

Once this operation has been performed, it is checked at step E505 whether there exist other electronic messaging addresses or other telephone numbers present in the electronic message received at step E500.

In the affirmative, the processor 300 passes to step E506, considers the electronic messaging address and passes to the previously described step E501.

The loop consisting of steps E501 to E506 is reiterated as long as not all the addresses have been processed.

It should be noted here that the addresses for the clients for whom the electronic message is intended and the messaging address 101 that sent the electronic message received at step E501 are stored.

Likewise, it should be noted here that the copy addresses of the electronic message are not stored according to the present invention.

When all the addresses present or telephone numbers in the electronic message have been processed, the processor 300 passes to the following step E507.

At this step, the processor 300 determines whether temporal information is contained in the electronic message received or is associated therewith.

This temporal information is for example the date and/or time of end of the collaboration session required, or even the time of establishment of the collaboration session.

This temporal information is associated in the form of an attachment to the electronic message. This attachment is for example of the eCalendar© or vCalendar© type. In another embodiment, this temporal information is inserted in the electronic message according to a predetermined format.

In the negative, the processor 300 passes to the following step E510.

If temporal information is contained in the electronic message received or is associated therewith, the processor 300 passes to step E508.

At step E508, the processor 300 activates a time delay for the start of activation of the collaboration session corresponding to the date and/or time of establishment of the collaboration session.

At the following step E509, the processor 300 awaits the date and/or time of the start of the collaboration session specified with the electronic message received.

When the date and/or time of the calendar and/or of the clock of the collaboration session activation device corresponds to the date and/or time of establishment of the collaboration session, the processor 300 passes to the following step E510.

At step E510, the addresses stored at step E503 are transferred to the collaboration session manager 125.

At the following step E511, the collaboration session manager 125 determines the type of session that the client initiating the electronic message received at step E500 wishes to establish.

The session type is for example determined from the address of the electronic mailbox at which the electronic message arrived.

If the session is a videoconference session, the address of the electronic mailbox at which the electronic message arrived is videoconference@domain.com.

If the session is an editing session in the form of a whiteboard, the address of the electronic mailbox at which the electronic message arrived is whitboard@domain.com.

In a variant, the collaboration session manager 125 determines the type of collaboration session by a search for predetermined keywords in the body of the electronic message received.

According to the type of collaboration session determined, the collaboration session manager 125 activates the corresponding collaboration session at step E512.

If no collaboration session type is specified, the collaboration session manager 125 activates the collaboration session considered by the collaboration session manager 125 to be the default collaboration session 126.

Once this operation has been performed, the collaboration session manager 125 stores at step E513 the memory address associated with the collaboration session activated.

Once this operation has been performed, the collaboration session manager 125 forms at step E514 an electronic message or an SMS or a MMS intended for each electronic messaging address or each telephone number transferred at step E510.

The electronic message is for example addressed to the client of the client communication devices 100a and 100b and comprises the following text information:

“Hello, A collaboration session has been created, click on the following link to join it: Space.abc.com/sidjsGwqAXg80/CFGMA?csl=m1&msl=m1&xsl=1&out=2.”

In which Space.abc.com/sidjsGwqAXg80/CFGMA?csl=m1&msl=m1&xsl=1&out=2 corresponds to the memory address associated with the collaboration session established previously at step E512.

It should be noted here that, in a variant, the accreditations determined previously at step E504 are also inserted in each electronic message.

The message thus formed is transferred at step E515 to the messaging software 122 associated with the collaboration session manager 125 in order to be sent to the various clients of the collaboration session established by means of the messaging server 110 and the communication network 150.

It should be noted here that, in a variant embodiment, the previously described steps E508 and E509 are not executed.

According to this variant, the processor 300 determines whether temporal information is contained in the electronic message received or is associated therewith.

If temporal information is contained in the electronic message received or is associated therewith, it is included in or associated with the message formed at step E514.

The collaboration session remains active as long as the test of the following step E516 is not positive. At this test, the processor 300 checks whether or not the time delay for the end of the collaboration session established at step E512 has terminated.

When the end of session time delay has terminated, the processor 300 demands the closure of the collaboration session established at step E512 and returns to step E500 awaiting the reception of a new message.

It should be noted here that, at any time during a collaboration session, a client of the collaboration session can broaden the number of clients participating in this collaboration session, without the latter being interrupted.

For this purpose, the client of the collaboration session composes an electronic message or a SMS or an MMS intended for the electronic messaging system 122 associated with the collaboration session manager 125 and with the clients and with the new client.

When the collaboration session manager 125 receives this message, it compares the addresses stored at step E503 in FIG. 5 with those contained in the message and adds the new address or telephone number as the client address of the current collaboration session.

The collaboration session manager then forms an electronic message or an SMS or an MMS comprising the address of the collaboration session to which the new client is invited and demands the transfer of the electronic message formed to the latter.

Naturally, several new clients can simultaneously be invited to share an active collaboration session.

Naturally the present invention is in no way limited to the embodiments described here but quite the contrary encompasses any variant within the capability of a person skilled in the art.

1. Method of transferring at least one message for the establishment of a collaboration session (126) by a manager (125) of a collaboration session between a plurality of clients, characterised in that a messaging system (122) is associated with the collaboration session manager and in that the method comprises the steps of:
the reception (E500), by the messaging system associated with the collaboration session manager, of a message generated by a collaboration session client, the message comprising a plurality of addresses of clients of the collaboration session,
the activation (E508) of a collaboration session by the collaboration session manager,
the obtaining (E513) of an identifier for the collaboration session activated,
the transfer (E515), for the establishment of the collaboration session, of at least one message intended for each collaboration session client address, the message comprising the identifier of the collaboration session activated.

2. Method according to claim 1, characterised in that the message generated by the client of the collaboration session is an electronic message comprising the messaging address of the client who generated the message and the messaging address of the other client of the collaboration session.

3. Method according to claim 2, characterised in that the temporal information is associated with the electronic message.

4. Method according to claim 2 or 3, characterised in that other messaging addresses are included in the electronic message and the method also comprises a step of determining, amongst the messaging addresses included in the electronic message, messaging addresses of the clients of the collaboration session.

5. Method according to claim 4, characterised in that a plurality of messaging addresses are associated with the messaging system associated with the collaboration session manager, and a type collaboration session corresponds to each messaging address.

6. Method according to claim 5, characterised in that accreditations are allocated to the clients of the collaboration session and in that the message transferred to each client of the collaboration session comprises the allocated accreditation.

7. Method of establishing a collaboration session between a plurality of clients of the collaboration session over a communication network (150), characterised in that the method comprises the steps of:
the reception, by a messaging system (101) associated with a client of the collaboration session, at least one message generated by a messaging system associated with a collaboration session manager, the message comprising the. identifier of an activated collaboration service,
the establishment, by the collaboration software (103) associated with the client, of a collaboration session from the identifier of the collaboration session activated.

8. Method according to claim 7, characterised in that the message generated by the messaging system associated with a collaboration session manager is an electronic message and in that temporal information is associated with the electronic message.

9. Method according to claim 8, characterised in that, prior to the establishment of the session, the method also comprises the steps of:
displaying the identifier of the collaboration session,
detecting a command made by the client for establishing the collaboration session.

10. Method according to claim 9, characterised in that, prior to the step of establishing a collaboration session, the method comprises a step of activating collaboration software associated with the client.

11. Method according to claim 10, characterised in that the method also comprises the step of generating, by means of the messaging system associated with the client of collaboration session, a message intended for the messaging system associated with the collaboration session manager, the message comprising the messaging address of the client of the collaboration session.

12. Device for transferring at least one message for the establishment of a collaboration session by a collaboration session manager between a plurality of clients, characterised in that a messaging system is associated with the collaboration session manager and in that the device comprises:
means for the reception, by the messaging system associated with the collaboration session manager, of a message generated by a collaboration session client, the message comprising a plurality of addresses of clients of the collaboration session,
means for the activation of a collaboration session by the collaboration session manager,
means for the obtaining of an identifier for the collaboration session activated,
means for the transfer, for the establishment of the collaboration session, of at least one message intended for each collaboration session client address, the message comprising the identifier of the collaboration session activated.

13. Device for establishing a collaboration session between a plurality of clients of the collaboration session over a communication network, characterised in that the device comprises:
means of receiving, by a messaging system associated with a client of the collaboration session, at least one message generated by a messaging system associated with a collaboration session manager, the message comprising the identifier of an activated collaboration session,
means of establishing, by means of the collaboration software associated with the client, a collaboration session from the identifier of the activated collaboration session.

14. System for establishing a collaboration session between a plurality of clients of the collaboration session over a communication network, characterised in that the system comprises:
means of generating, by means of a messaging system associated with a client of the collaboration application, a message intended for a messaging system associated with a collaboration session manager, the message including the address of the clients of the collaboration session,
means for the activation of a collaboration session by the collaboration session manager,
means of obtaining an identifier of the collaboration session activated,
means for the transfer, for establishing the collaboration session, of at least one message intended for each collaboration session client messaging address, the message comprising the identifier of the collaboration session activated,
means for the establishment, by the collaboration software associated with the client, of a collaboration session from the identifier of the collaboration session activated.

15. Computer program stored on an information medium, the said program containing instructions for implementing the method according to any one of claims 1 to 6, when it is loaded into and executed by a computer system.

16. Computer program stored on an information medium, the said program containing instructions for implementing the method according to any one of claims 7 to 1, when it is loaded into and executed by a computer system.
